(19) United States
(12) Patent Application Publication
(10) Pub. No.: US 2013/0160519 A1
(43) Pub. Date: Jun. 27, 2013

(54) IMPACTING HEAD AND IMPACT TESTING DEVICE USING THE SAME

(71) Applicants: DI-GANG ZHAI, Shenzhen City (CN); YUAN-WANG LIU, Shenzhen City (CN); GUANG-MING WEN, Shenzhen City (CN)

(72) Inventors: DI-GANG ZHAI, Shenzhen City (CN); YUAN-WANG LIU, Shenzhen City (CN); GUANG-MING WEN, Shenzhen City (CN)

(21) Appl. No.: 13/653,117

(22) Filed: Oct. 16, 2012

(30) Foreign Application Priority Data
Dec. 21, 2011 (CN) 201110432406.3

(51) Int. Cl. G01N 3/30

(52) U.S. Cl. CPC G01N 3/30
USPC 73/12.09

(57) ABSTRACT

An impacting head using in an impact testing device comprises a substrate made of aluminum or aluminum alloy and a rubber head made of polyurethane resin, the substrate and the rubber head are bonded together by adhesive layer mainly containing epoxy resin. The impacting head has low cost and a long service life. Furthermore, the impacting head produces a display of trapezoidal waves following impact tests which meets the requirements of the IEC 60068-2-27 2008 standard.

### BACKGROUND

1. Technical Field

The present disclosure relates to an impacting head and an impact testing device using the impacting head.

2. Description of Related Art

Electronic devices, such as mobile phones, are impact tested to test their impact resistance. FIG. 1 shows a typical impact testing device 100, which includes a worktable 17, an impacting head 13 positioned on one side of the worktable 17, a gas cylinder 15 aligned with the impacting head 13, and a lifting element 11. The worktable 17 supports the electronic device. In use of the impact testing device 100, a gas, such as nitrogen, is first fed into the gas cylinder 15 until a desired pressure is reached. The lifting element 11 drives the worktable 17 to rise to a height and then releases the worktable 17. Thus, the worktable 17 together with the electronic device fall down until the impacting head 13 hits the gas cylinder 15 to simulate an impact to test the electronic device. A piezoelectric transducer (not shown) records the force of the impact and transmits electrical signals to a controller (not shown), the controller then converts the electrical signals to digital signals and transmits the digital signals to a computer (not shown). The computer processes the digital signals to show a trapezoidal wave as shown in FIG. 4 on a display (not shown). The trapezoidal wave should meet the requirements of International Electrotechnical Commission (IEC) 60068-2-27 2008 standard.

During the impact process, the impacting head 13 is an important element. The collision between the impacting head 13 and the gas cylinder 15 is subject to certain requirements concerning the properties of the impacting head 13 and the gas cylinder 15. The typical impacting head 13 is made of rubber and formed by molding process, which prices the impacting head 13 at about $1,000.

Therefore, there is room for improvement within the art.

### BRIEF DESCRIPTION OF THE FIGURES

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of an impact testing device.

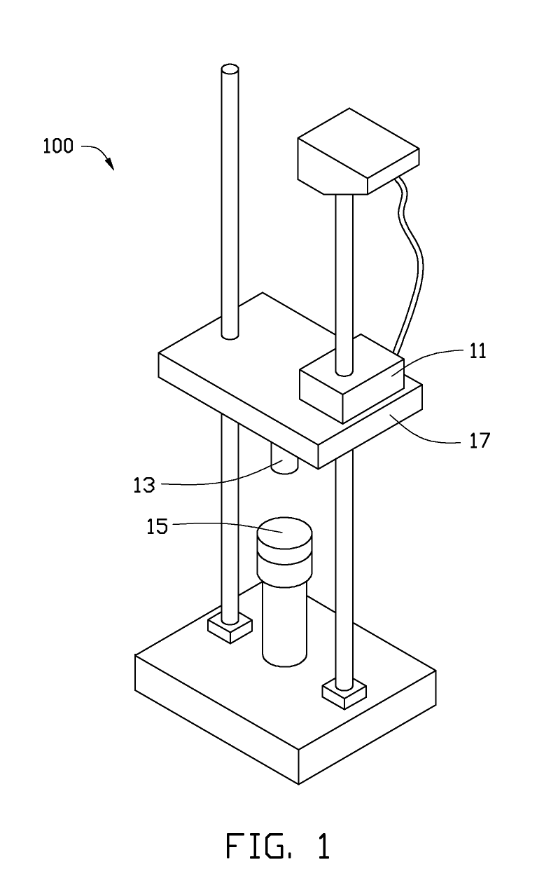

FIG. 2 is a schematic view of an exemplary embodiment of an impacting head.

FIG. 3 is an exploded view of the impacting head shown in FIG. 2.

FIG. 4 is a first trapezoidal wave produced by a first impact between the impacting head and a gas cylinder.

FIG. 5 is a second trapezoidal wave produced by a second impact between the impacting head and a gas cylinder.

FIG. 6 is a third trapezoidal wave produced by a third impact between the impacting head and a gas cylinder.

FIG. 7 is a fourth trapezoidal wave produced by a forth impact between the impacting head and a gas cylinder.

FIG. 8 is a fifth trapezoidal wave produced by a fifth impacting between the impacting head and a gas cylinder.

FIG. 9 is a sixth trapezoidal wave produced by a sixth impact between the impacting head and a gas cylinder.

FIG. 10 is a seventh trapezoidal wave produced by a seventh impact between the impacting head and a gas cylinder.

FIG. 11 is a eighth trapezoidal wave produced by a eighth impact between the impacting head and a gas cylinder.

FIG. 12 is a ninth trapezoidal wave produced by a ninth impact between the impacting head and a gas cylinder.

### DETAILED DESCRIPTION

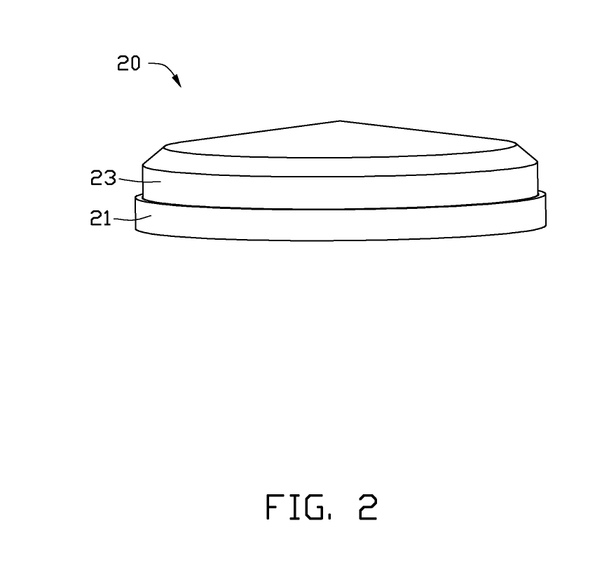

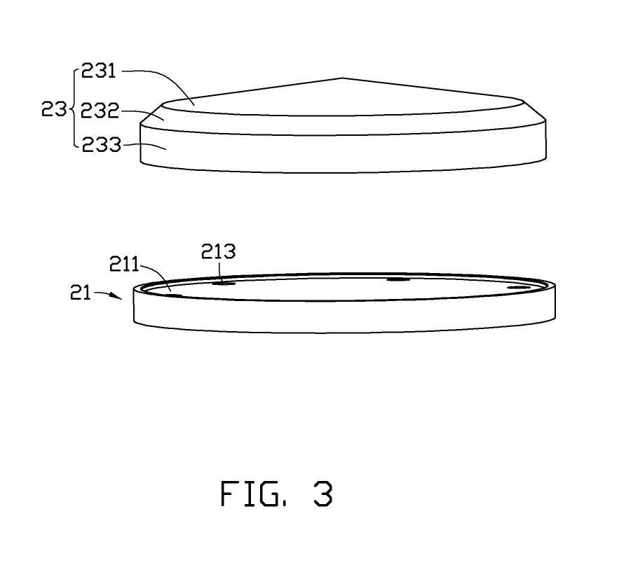

FIGS. 2 and 3 show an impacting head 20 according to an exemplary embodiment. The impacting head 20 includes a substrate 21 and a rubber head 23. The substrate 21 and the rubber head 23 are bonded together by adhesives. The adhesive mainly contains epoxy resin.

The substrate 21 is made of aluminum or aluminum alloy. The rubber head 23 is made of polyurethane resin which contains elements of carbon, oxygen, and chlorine, wherein the atomic percentage of the carbon is about 75% to about 77%, the atomic percentage of the oxygen is about 19% to about 21%, and the atomic percentage of the chlorine is about 4% to about 4.3%. The density of the rubber head 23 is about 1.12 to about 1.14 g/cm³. The Shore A hardness is about 25 to about 27.

The substrate 21 is generally disc-shaped. The substrate 21 defines a circular groove 211 for receiving the rubber head 23. The groove 211 defines a plurality of screw holes 213 for screws to secure the impacting head 20 on the impact testing device 100.

The rubber head 23 includes a distal surface 231, an intermediate portion 232, and an engaging portion 233. The engaging portion 233 is cylindrical and has a shape and size matching the groove 211. The engaging portion 233 is partially received in the groove 211. The intermediate portion 232 extends from the engaging portion 233, and the cross-sectional diameter of the intermediate portion 232 decreases from the engaging portion 233 to the distal surface 231. The distal surface 231 extends from the intermediate portion 232 and is conical.

The ratio of the diameter of the engaging portion 233 to the diameter at the bottom surface of the distal surface 231 is about 7:8 to about 9:10. The ratio of vertical heights of the engaging portion 233, the intermediate portion 232, and the distal surface 231 is respectively (7-9):(4-5): and (4.5-6).

In the embodiment, the engaging portion 233 has a diameter of 91.4 mm, and the engaging portion 233 has a height of 8.5 mm. The intermediate portion 232 has a vertical height of 4.5 mm. The distal surface 231 has a diameter at the bottom surface of 81.67 mm and a vertical height of 5.36 mm.

The rubber head 23 can be formed in any desired size.

The impacting head 20 is suitable for any impact testing device which leads to a display of trapezoidal waves as a result of the impact between an impacting head and a gas cylinder.

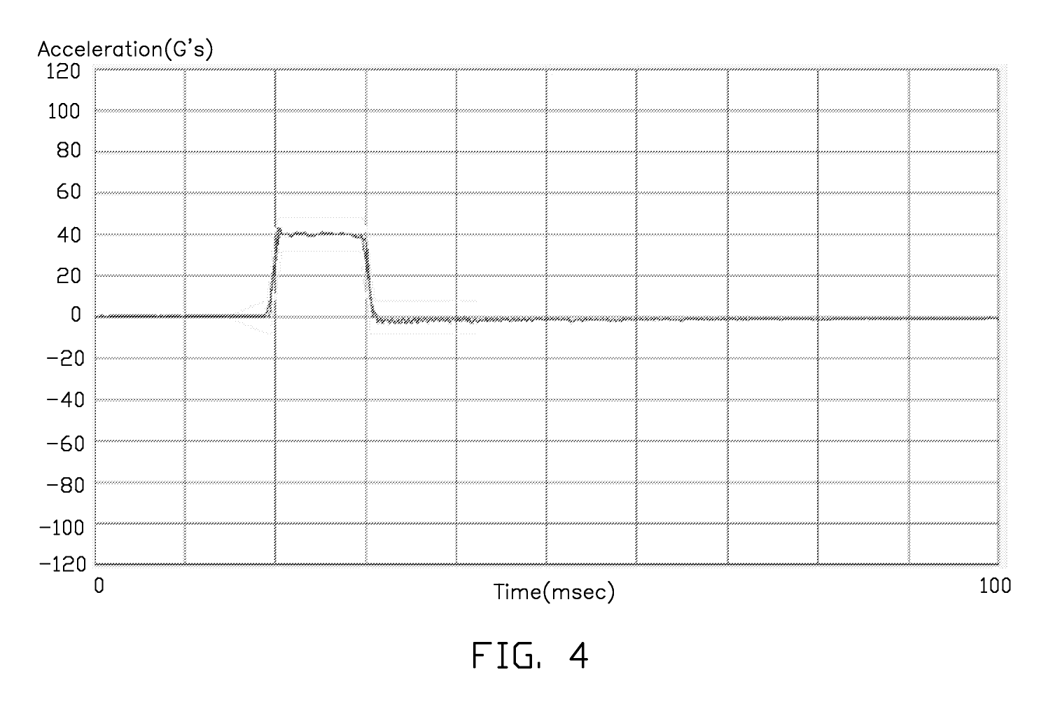

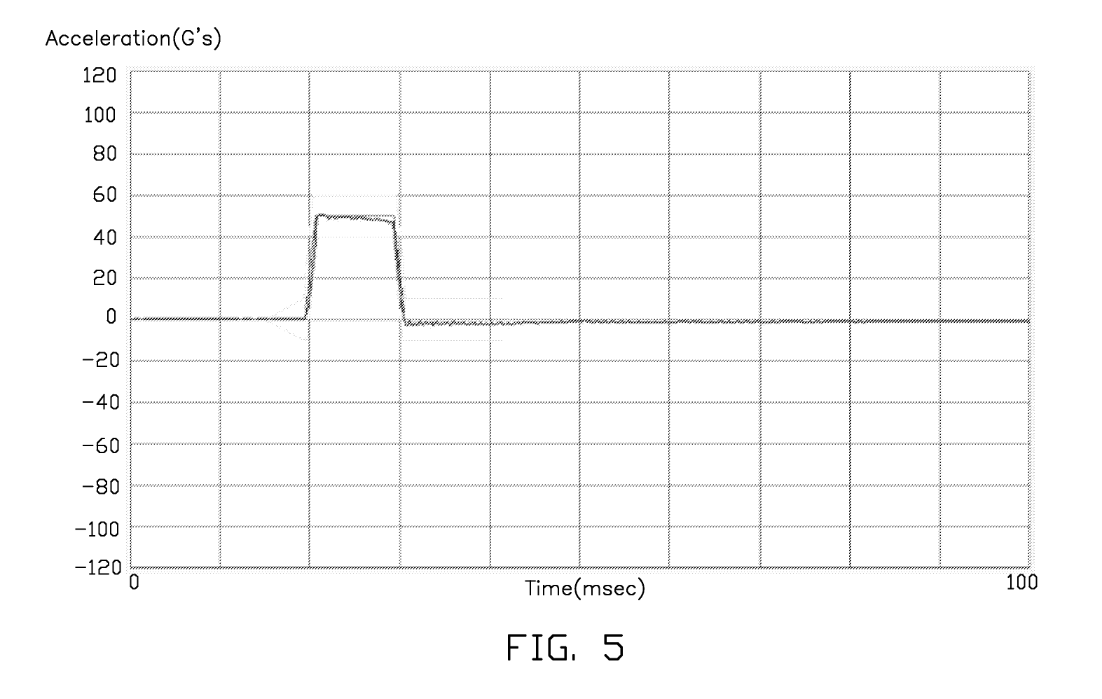

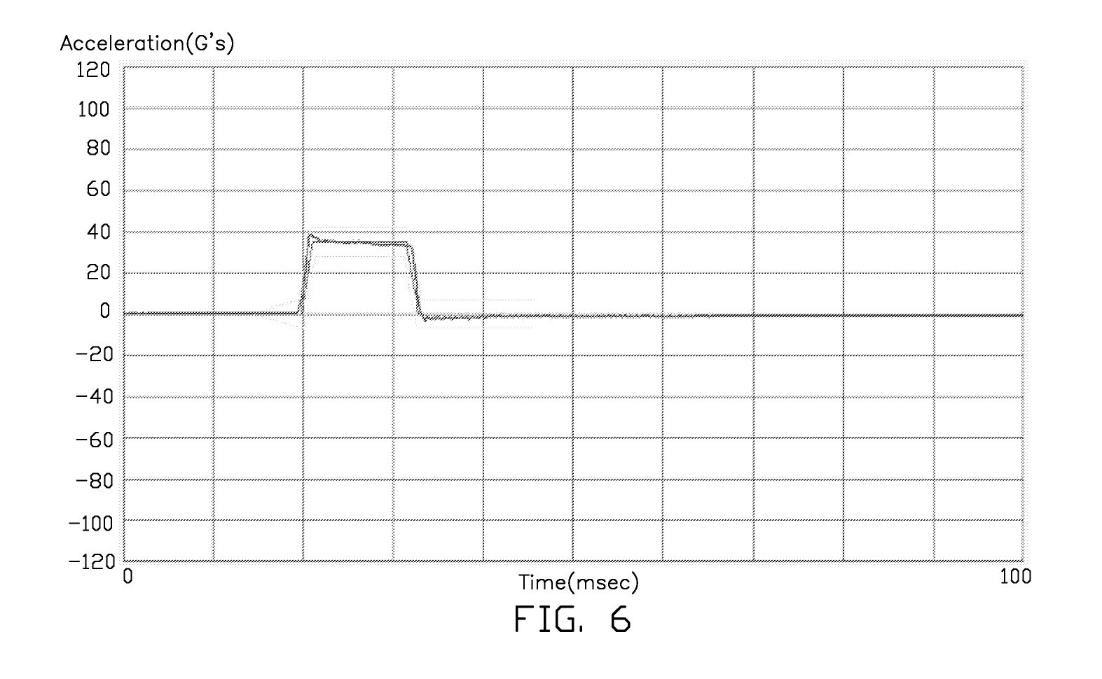

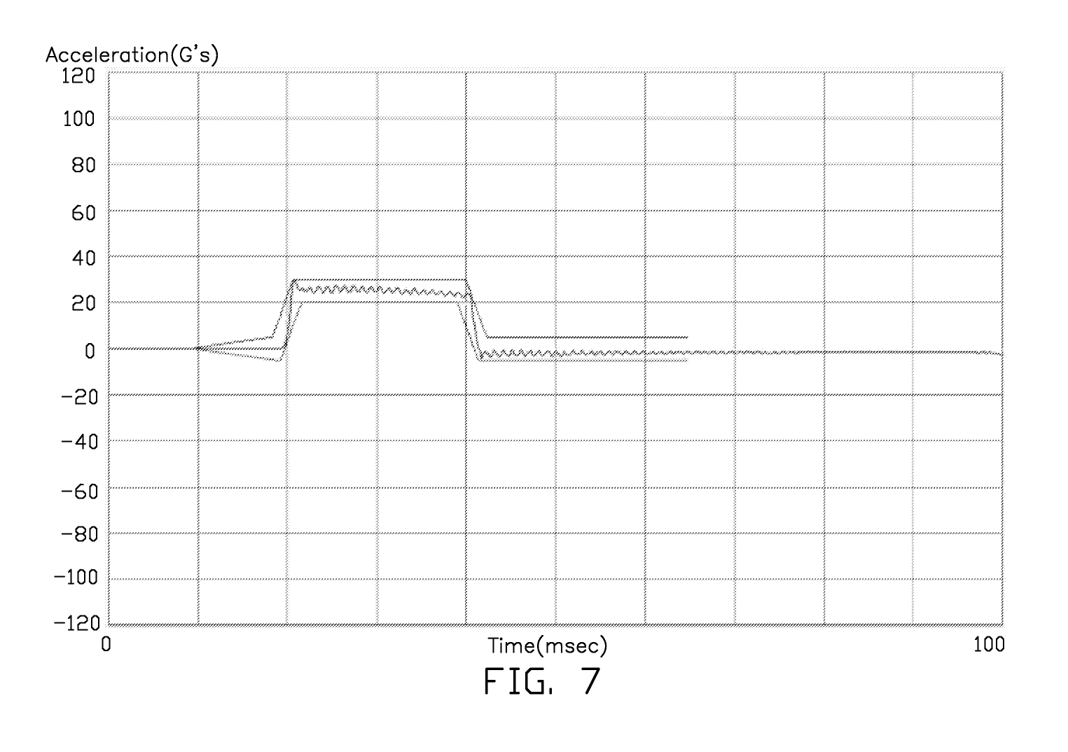

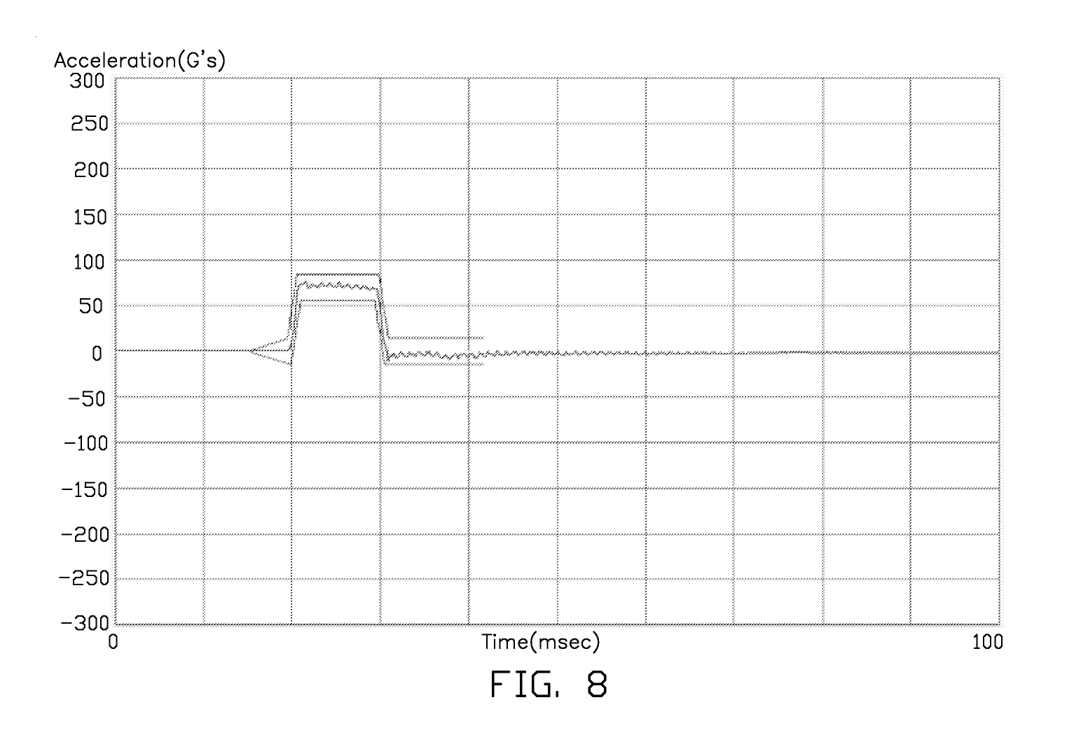

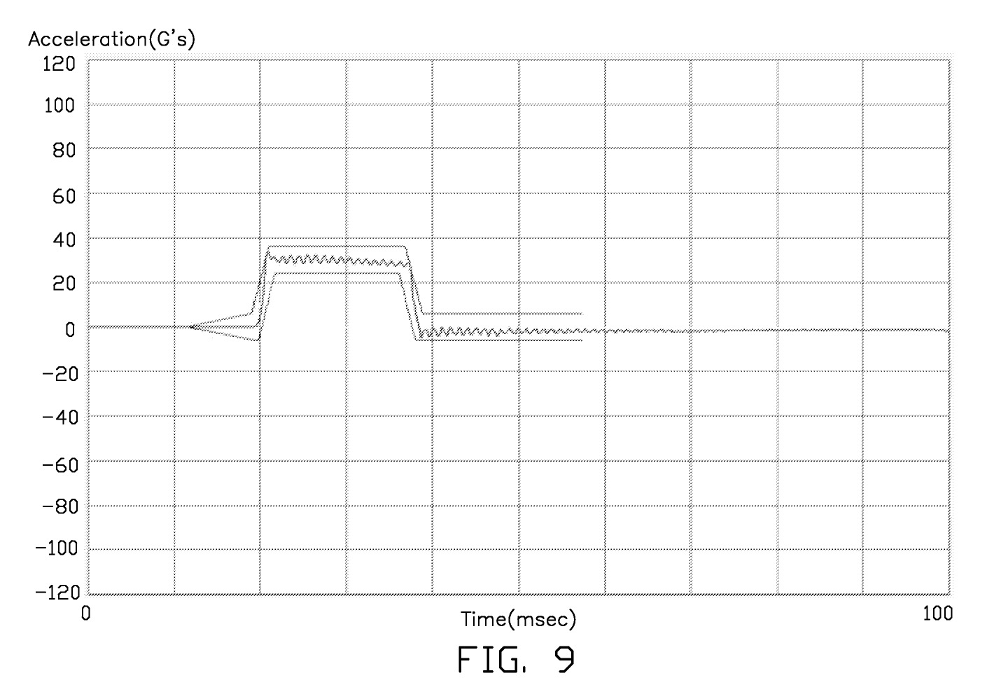

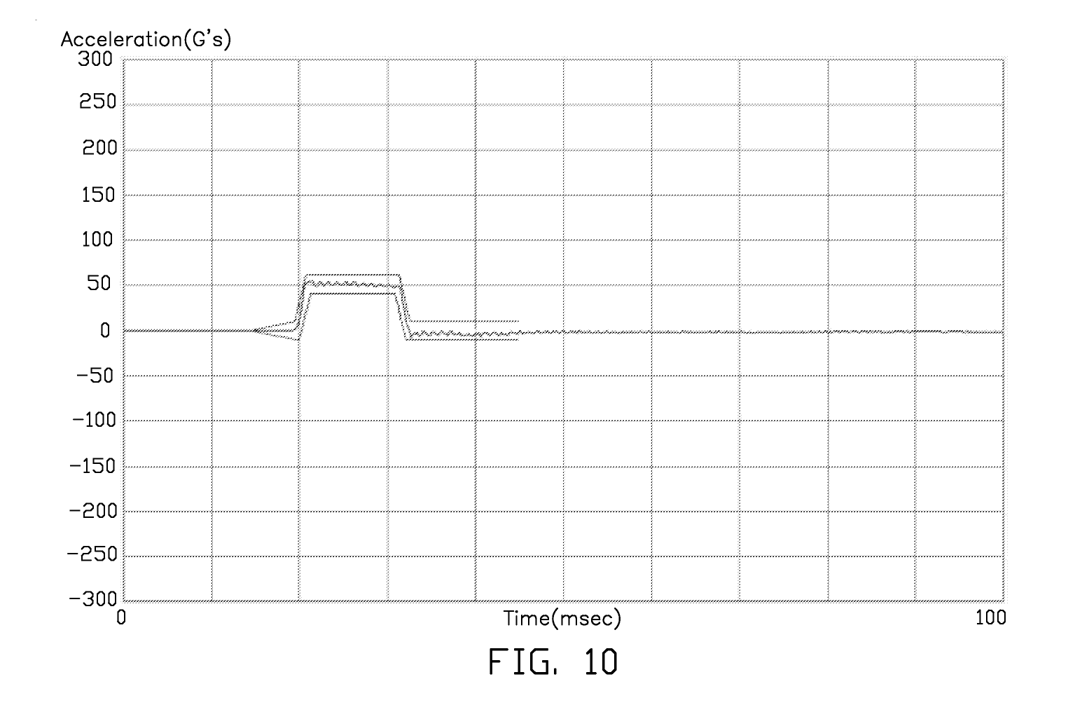

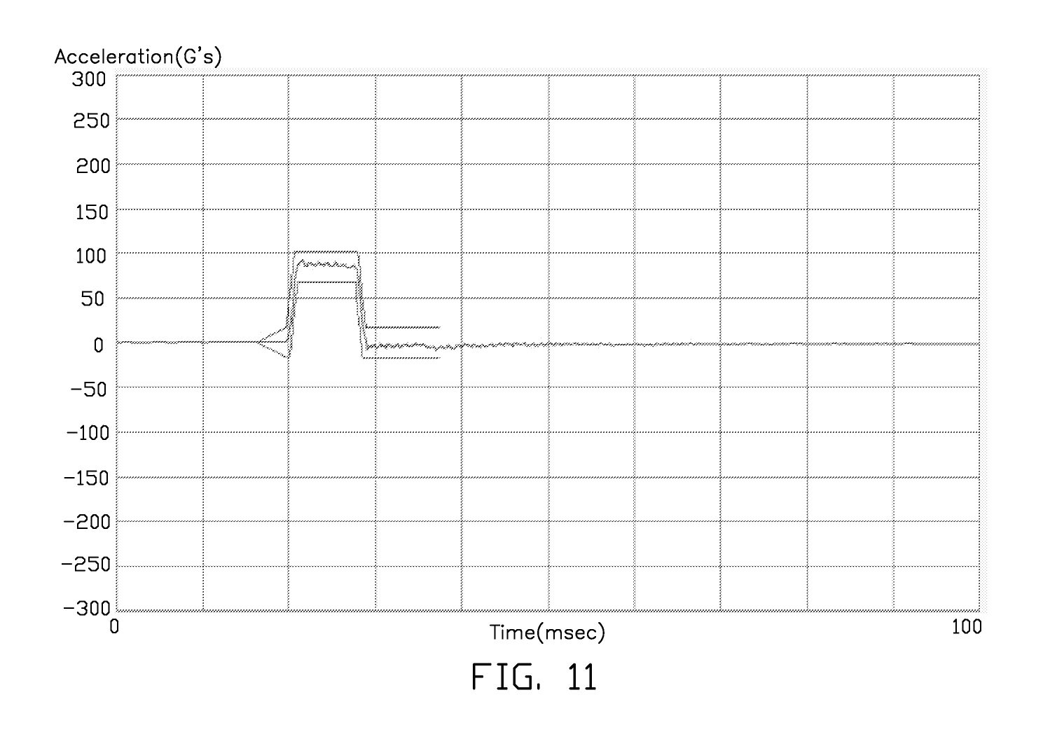

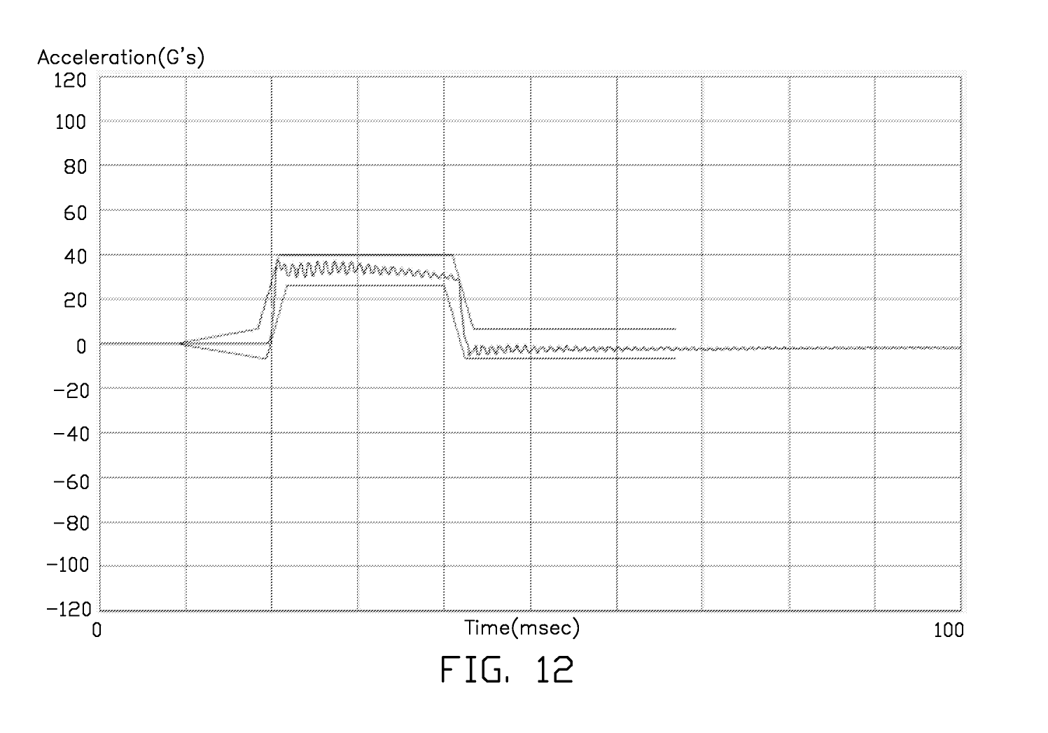

The impacting head 20 of the present disclosure is mounted on the impact testing device 100. Then a plurality of shock tests are implemented to obtain a plurality of trapezoidal waves as shown in FIGS. 4-12. Every “status” shown in FIGS. 4-12 is “In band”, which indicates that all the trapezoidal waves meet the requirements of the IEC 60068-2-27 2008 standard and the impacting head 20 of the present disclosure is in all respects qualified.

The impacting head 20 of the present disclosure is made by the rubber head 23 and the substrate 21 bonding together. The impacting head 20 has a very long service life and the cost is much lower. Furthermore, the impacting head 20 will produce trapezoidal waves which meet the requirements of the IEC 60068-2-27 2008 standard on hitting the gas cylinder.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An impacting head used in an impact testing device, the impacting head comprising:
a substrate made of aluminum or aluminum alloy;
a rubber head made of polyurethane resin; and
an adhesive layer between the substrate and the rubber head, the adhesive layer mainly containing epoxy resin.

2. The impacting head as claimed in claim 1, wherein the polyurethane resin comprises elements of carbon, oxygen, and chlorine, wherein the atomic percentage of the carbon is about 75% to about 77%, the atomic percentage of the oxygen is about 19% to about 21%, and the atomic percentage of the chlorine is about 4% to about 4.3%.

3. The impacting head as claimed in claim 1, wherein the rubber head has a density of about 1.12 to about 1.14 g/cm³.

4. The impacting head as claimed in claim 1, wherein the rubber head has a shore A hardness of about 25 to about 27.

5. The impacting head as claimed in claim 1, wherein the substrate defines a circular groove for receiving the rubber head.

6. The impacting head as claimed in claim 5, wherein the rubber head comprises a distal surface, an intermediate portion, and an engaging portion, the engaging portion is cylindrical and partially receives in the groove, the intermediate portion extends from the engaging portion, and the cross-sectional diameter of the intermediate portion decreases from the engaging portion to the distal surface, the distal surface extends from the intermediate portion and is conical.

7. The impacting head as claimed in claim 6, wherein the ratio of the diameter of the engaging portion to the diameter at the bottom surface of the distal surface is about 7:8 to about 9:10, the ratio of vertical heights of the engaging portion, the intermediate portion, and the distal surface is (7-9):(4-5):(4.5-6).

8. The impacting head as claimed in claim 7, wherein the engaging portion has a diameter of 91.4 mm and a height of 8.5 mm, the intermediate portion has a vertical height of 4.5 mm, the distal surface has a diameter at the bottom surface of 81.67 mm and a vertical height of 5.36 mm.

9. An impact testing device comprising:
a worktable;
a gas cylinder;
an impacting head positioned on the worktable aligning with the gas cylinder; and
a lifting element connected to the worktable to drive the worktable to rise and release the worktable to allow the worktable to fall down until the impacting head hits the gas cylinder;
wherein the impacting head comprises a substrate made of aluminum or aluminum alloy, a rubber head made of polyurethane resin, and an adhesive layer between the substrate and the rubber head, the adhesive layer mainly containing epoxy resin.

10. The impact testing device as claimed in claim 9, wherein the polyurethane resin contains elements of carbon, oxygen, and chlorine, wherein the atomic percentage of the carbon is about 75% to about 77%, the atomic percentage of the oxygen is about 19% to about 21%, and the atomic percentage of the chlorine is about 4% to about 4.3%.

11. The impact testing device as claimed in claim 9, wherein the rubber head has a density of about 1.12 to about 1.14 g/cm³.

12. The impact testing device as claimed in claim 9, wherein the rubber head has a shore A hardness of about 25 to about 27.

13. The impact testing device as claimed in claim 9, wherein the substrate defines a circular groove for receiving the rubber head.

14. The impact testing device as claimed in claim 13, wherein the rubber head comprises a distal surface, an intermediate portion, and an engaging portion, the engaging portion is cylindrical and partially receives in the groove, the intermediate portion extends from the engaging portion, and the cross-sectional diameter of the intermediate portion decreases from the engaging portion to the distal surface, the distal surface extends from the intermediate portion and is conical.

15. The impact testing device as claimed in claim 13, wherein the ratio of the diameter of the engaging portion to the diameter at the bottom surface of the distal surface is about 7:8 to about 9:10, the ratio of vertical heights of the engaging portion, the intermediate portion, and the distal surface is (7-9):(4-5):(4.5-6).

16. The impact testing device as claimed in claim 15, wherein the engaging portion has a diameter of 91.4 mm and a height of 8.5 mm, the intermediate portion has a vertical height of 4.5 mm, the distal surface has a diameter at the bottom surface of 81.67 mm and a vertical height of 5.36 mm.
